(19) United States
(12) Patent Application Publication
(10) Pub. No.: US 2010/0115562 A1
(43) Pub. Date: May 6, 2010

(54) AUDIO SYSTEM AND MAIN BOX

(75) Inventor: Tomohide Koike, Tokyo (JP)

Correspondence Address: WOLF GREENFIELD & SACKS, P.C., 600 ATLANTIC AVENUE, BOSTON, MA, 02210-2206, US

(73) Assignee: SONY CORPORATION, Tokyo (JP)

(21) Appl. No.: 12/610,473

(22) Filed: Nov. 2, 2009

(30) Foreign Application Priority Data
Nov. 4, 2008 (JP) 2008-282736

(51) Int. Cl. H04N 7/18; H04B 3/00

(52) U.S. Cl. 725/78; 381/77

(57) ABSTRACT

The present invention is applied to an audio system for transmitting audio signals and video signals to each room of a house via cables installed within the walls of the house, and for reproducing these audio signals and video signals in the each room, for example, and thereby enables more improvement in usability of this kind of audio system than before.

The present invention outputs the audio signals of one source unit to all of a plurality of zone units when a party mode is selected in one of the plurality of zone units.

### BACKGROUND OF THE INVENTION

1. Field of the Invention

The present invention relates to an audio system and a main box, which can be applied to an audio system for transmitting audio signals and video signals to each room of a house via cables installed within the walls of the house, and reproducing these audio signals and video signals in the each room, for example. When a party mode is selected in one of a plurality of zone units, the present invention outputs the audio signals of one source unit to all of the plurality of zone units, thereby enabling more improvement in usability of this kind of audio system than before.

2. Description of the Related Art

In the United States and other countries, there is provided an audio system in the related art which transmits audio signals to each room of a house via cables installed within the walls and reproduces the audio signals from a speaker embedded in the wall. In this audio system, a music source device is placed at a predetermined position within a house and audio signals output from this music source device are transmitted to each room. Furthermore, in this audio system, each room is provided with a controller which controls transmission of audio signals and the like. Consequently, system configuration of this kind of audio system differs depending on each house, and hence each device for configuring the system has a high extensibility.

Regarding this kind of audio system, there is proposed in Japanese Unexamined Patent Application Publication No. 2000-59408 a method for optimizing resource sharing in home network.

### SUMMARY OF THE INVENTION

By the way, it is considered as more convenient if the usability of this kind of audio system can be further improved.

The present invention has been made in view of the above point and it is desirable to provide an audio system and a main box of the audio system enabling more improvement in usability than before.

According to an embodiment of the present invention, there is provided an audio system which includes a plurality of source units each of which outputs audio signals and video signals, a plurality of zone units for outputting control data according to user's operation and outputting audio signals from a speaker as well as displaying video signals, each of the plurality zone units being placed at a desired position in a house, and

a main box for selectably outputting the audio signals and video signals of the source unit to the zone unit according to the control data. When a party mode is selected in one of the plurality of zone units, the main box outputs, by the control data, the audio signals of the source unit selected in the one zone unit to all of the plurality of zone units.

According to another embodiment of the present invention, there is provided a main box for selectively outputting audio signals and video signals output from a plurality of source units to a zone unit by control data from the zone unit, the main box being connected, via the cables installed in the walls within the house, to the plurality of zone units each of which outputs video signals and audio signals and to the plurality of source units each of which reproduces video signals and audio signals. Here, when a party mode is selected in one of the plurality of zone units, the main box outputs, by the control data, audio signals of the source unit selected in the one zone unit to all of the plurality of zone units,

According to the above embodiments of the present invention, in the configuration where various sources are shared by the plurality of zone units and each of the zone units reproduces a desired content, the audio signals of one content can be reproduced in all of the zone units by an operation in one of the zone units. Because of this, more improvement in usability can be obtained than before.

According to the present invention, usability can be more improved than before.

### BRIEF DESCRIPTION OF THE DRAWINGS

FIG. 1 is a block diagram showing an audio system according to an embodiment of the present invention;

FIG. 2 is a plan view showing a main box in the audio system in FIG. 1;

FIG. 3 is a block diagram of the main box in FIG. 2;

FIG. 4 is a plan view showing a keypad in the audio system in FIG. 1;

FIG. 5 is a block diagram of the keypad in FIG. 4;

FIG. 6 is a flowchart showing a processing procedure in intercom mode;

FIG. 7 is a flowchart showing a processing procedure in door intercom mode;

FIG. 8 is a flowchart showing a processing procedure in monitor mode;

FIG. 9 is a flowchart showing a processing procedure in party mode;

FIG. 10 is a block diagram showing a connection in version update processing; and

FIG. 11 is a flowchart showing a processing procedure in the version update processing.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted. In addition, the explanation will be made in the following order.

1. First embodiment

2. Modification

### First Embodiment

### Configuration of the Embodiment

### [Overall Configuration]

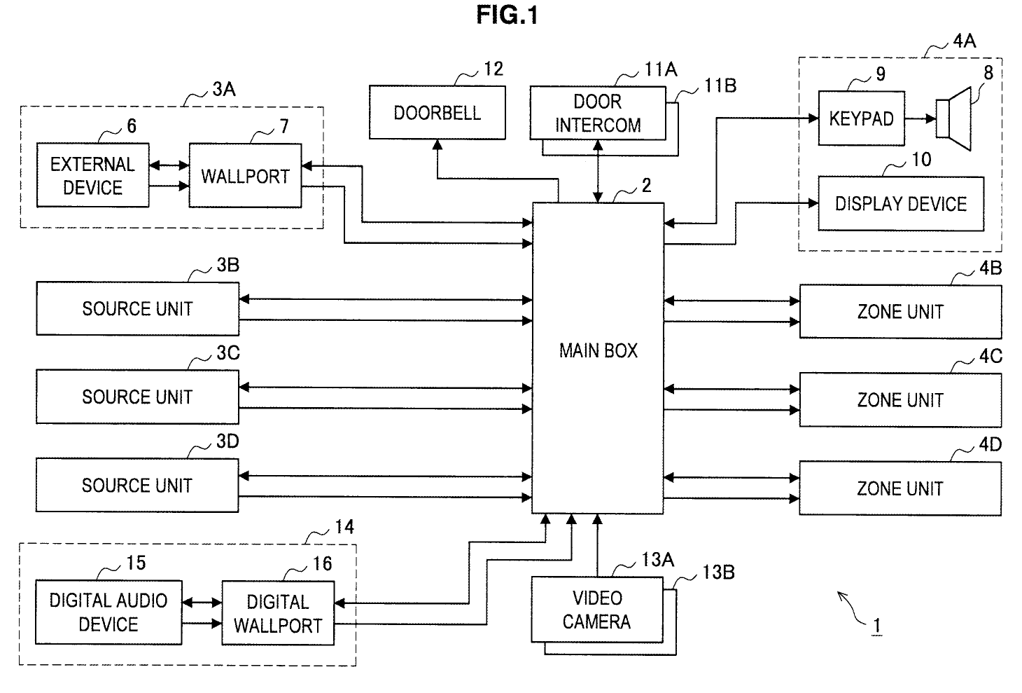

FIG. 1 is a block diagram showing an audio system according to an embodiment of the present invention. This audio system 1 transmits audio signals and video signals to each room of a house via cables installed within the walls and reproduces the audio signals and video signals in the each room.

In this audio system 1, a main box 2 is placed at an inconspicuous position in a basement or the like, and source units 3A to 3D are placed, for example, at the placement position of the main box 2, in a listening room, or the like. Furthermore, each of the zone units 4A to 4D is placed in each room. In addition, the source units 3A to 3D can be placed respectively in the same room as the zone units 4A to 4D. In the audio system 1, the source units 3A to 3D and the zone units 4A to 4D are connected to the main box 2 via cables installed within the walls. This audio system 1 transmits audio signals and video signals output from these source units 3A to 3D to each of the zone units 4A to 4D from the main box 2 and reproduce them.

Here, the source units are the units on the source side, each of which selects content by control of the main box 2, and outputs the audio signals and video signals of this selected content to the main box 2. Each of the source unit of 3A to 3D is provided with an external device 6 for outputting audio signals or audio signals and video signals, and a wallport 7 for configuring an interface between this external device 6 and the main box 2.

Here, the external device 6 is an audio device or an AV device functioning as either a dedicated AV receiver or a source. The dedicated AV receiver is a pre-main amplifier which is installed in a listening room or the like, and has a function of receiving FM broadcasting and television broadcasting, an external input function, a selector function, and an external output function. This dedicated AV receiver switches operation by control data transmitted from the main box 2 via the wallport 7 and outputs audio signals and video signals to the wallport 7. Furthermore, the dedicated AV receiver controls an external device connected to the external input terminal, and selects video signals and audio signals to be input to the external input terminal and outputs the selected signals to the wallport 7.

Accordingly, the audio system 1 can be configured capable of, when this dedicated AV receiver is applied to the external device 6, adding a desired audio device or AV device by using the external input terminal of this AV receiver. Furthermore, video signals and audio signals of the external device 6 of another source unit can be directly input to the external input terminal of this AV receiver and the external device 6 of such another source unit can be used in a listening room or the like. On the other hand, the audio device functioning as a source is, for example, a compact disk player or a FM tuner. In addition, the AV device functioning as a source is, for example, a television tuner.

The wallport 7 is an input and output terminal which is placed on the wall. The wallport 7 outputs the control data output from the main box 2 to the external device 6, and outputs the audio signals and video signals output from the external device 6 to the main box 2.

The zone units 4A to 4D are terminal units which are placed in rooms or the like. The zone units 4A to 4D output control data to the main box 2 being actuated according to a user's operation, and reproduce the audio signals and video signals transmitted from the main box 2. Each of the zone units 4A to 4D is provided with an external speaker 8 embedded in the wall, a keypad 9 for outputting control data to the main box 2 as well as driving the external speaker 8 by the audio signals output from the main box 2, and a display device 10 for reproducing the video signals output from the main box 2. In addition, the display device 10 is placed if necessary.

The main box 2 switches operation by the control data output from the zone unit of 4A to 4D, and controls the operation of each of the source units 3A to 3D. By this switch of operation, the main box 2 selectively outputs the audio signals and the video signals input from the each unit to the zone unit of 4A to 4D.

More specifically, the main box 2 selects the audio signals and video signals output from a desired source unit of 3A to 3D and outputs the selected signals to the zone unit of 4A to 4D as well as outputting control data to the external device 6 provided in the source unit of 3A to 3D. As a result, in this audio system 1, source or content can be selected by the operation of the keypad 9 in each room and the selected content can be enjoyed in the each room.

### [Configuration According to an Extension Function]

Here, the keypad 9 switches operation mode to intercom mode by a user's operation. Here, the intercom mode is an operation mode for transmitting and receiving speech signals among the keypads 9 by using the keypad 9 as a terminal device of an intercom. The keypad 9 transmits the speech signals acquired by the internal microphone to the main box 2. The main box 2 transmits these speech signals to another zone unit of 4A to 4D, and such another zone unit of 4A to 4D outputs the transmitted speech sounds from the internal speaker after muting audio signals. Furthermore, on the contrary to this, such another zone unit of 4A to 4D acquires speech signals and transmits the speech signals back to one of the zone units 4A to 4D via the main box 2. Because of this, in the audio system 1, each of the zone units 4A to 4D is used as a terminal of the intercom, and it is possible to communicate between the rooms provided with the zone units 4A to 4D.

Furthermore, the main box 2 can be connected with door intercoms 11A and 11B, and when a button for calling is operated on the intercom 11A or 11B, activates a doorbell 12 and outputs ringing sound. Furthermore, the main box 2 outputs the speech signals output from the door intercom 11A or 11B to the corresponding zone unit of 4A to 4D by control of the zone unit of 4A to 4D, and transmits the speech signals acquired by this zone unit of 4A to 4D back to the door intercom 11A or 11B and outputs them. At this time, the corresponding zone unit of 4A to 4D outputs the transmitted speech signals from the internal speaker after muting audio signals, and outputs speech signals acquired by a microphone back to the main box 2. Because of this, in the audio system 1, each of the zone units 4A to 4D can be used as a terminal of the door intercoms 11A and 11B, and a user can talk with a visitor while being in a room.

Furthermore, the main box 2 receives video signals for monitoring from video cameras 13A and 13B and outputs these video signals for monitoring to a desired zone unit of 4A to 4D by control of the keypad 9. Because of this, in this audio system 1, it is possible to monitor, for example, a pet or a visitor at the entrance from each of the rooms provided with the zone units 4A to 4D.

A digital source unit 14 is a unit on the source side for using a digital audio device 15 such as a portable music player as a music source. The digital source unit 14 outputs the control data output from the main box 2 to the digital audio device 15 via a digital wallport 16. Furthermore, the digital source unit 14A outputs the digital audio signals output from the digital audio device 15 via the digital wallport 16 back to the main box 2. The main box 2, as for the digital source unit 14 in the same way as the source unit of 3A to 3D, outputs control data as well as receiving the audio digital signals and selectively outputting them to the zone unit of 4A to 4D. Because of this, in the audio system 1, music content stored in a portable music player or the like can be enjoyed in each of the rooms provided with zone units 4A to 4D.

### [Detailed Configuration of the Main Box]

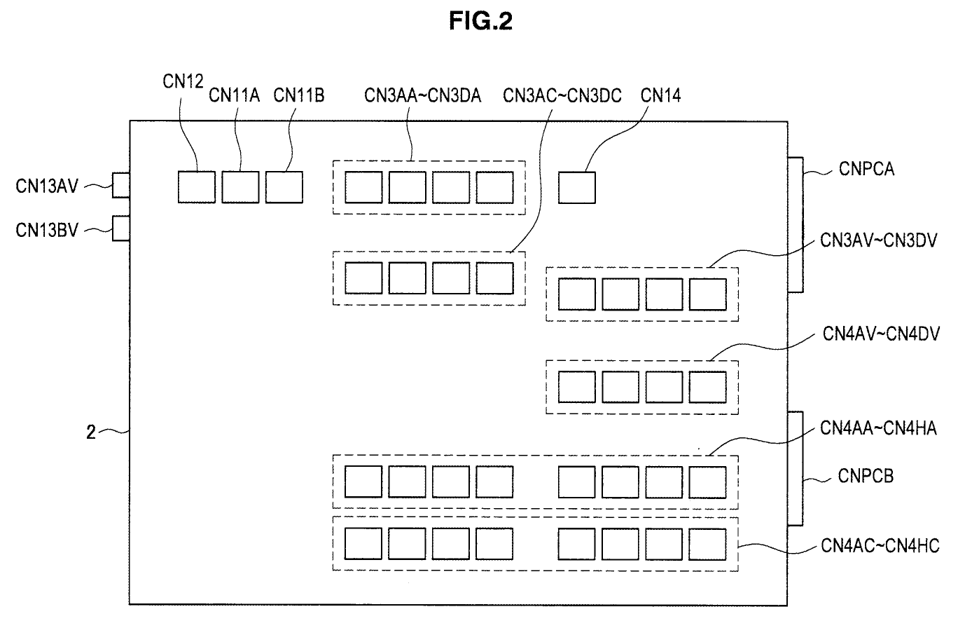

FIG. 2 is a plan view showing an external configuration of the main box 2. The main box 2 is formed in a box shape, and the upper surface is provided with connectors CN11A, CN11B, CN12, and CN14 which connect each of the door incomes 11A and 11B, doorbell 12, and the digital source unit 14. Furthermore, this upper surface is provided with connectors CN3AA to CN3DA, CN3AC to CN3DC, and CN3AV to CN3DV for audio signals, data communication signals, and video signals which connect each of the source units 3A to 3D. Furthermore, this upper surface is provided with connectors CN4AA to CN4HA, CN4AC to CN4HC, and CN4AV to CN4DV for audio signals, data communication signals, and video signals which connect each of the zone units 4A to 4D.

In addition, the connectors CN4AA to CN4HA and CN4AC to CN4HC for audio signals and for data communication signals which connect the zone units 4A to 4D are provided for eight sets. On the contrary, the CN4AV to CN4DV for video signals which connect the zone units 4A to 4D are provided for four sets. Consequently, the main box 2 can connect up to eight sets of zone units, but the four sets out of eight are terminals not provided with the display device 10 and only reproduce audio signals.

Furthermore, the sides of the main box 2 are respectively provided with connectors CN13AV and CN13BV for receiving video signals for monitoring and connectors CNPCA and CNPCB which are connected to computers.

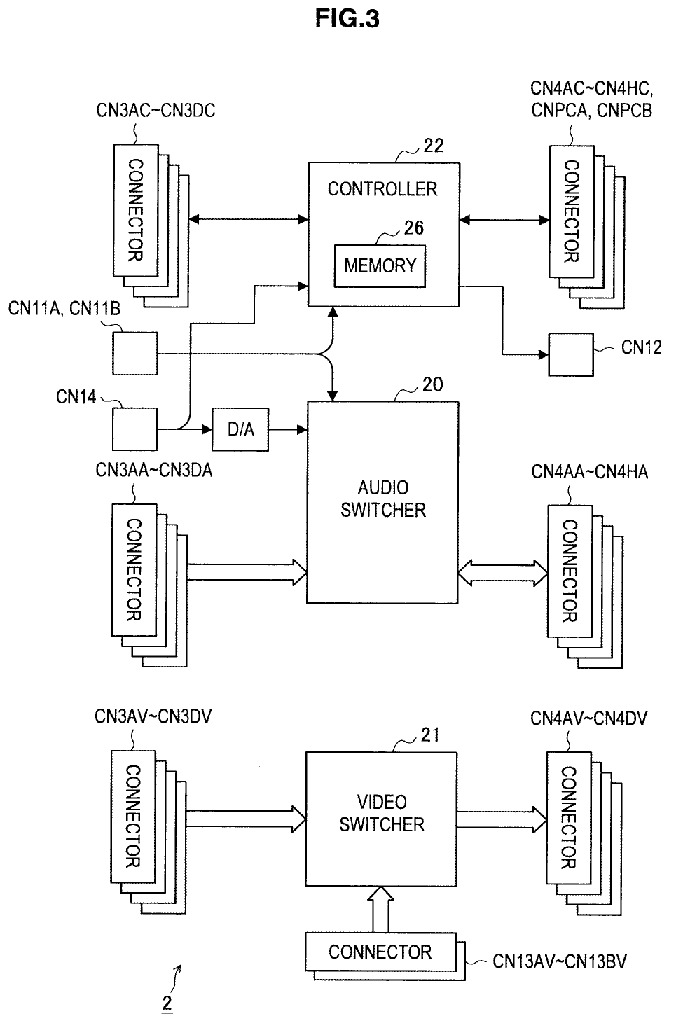

FIG. 3 is a block diagram showing a detailed configuration of the main box 2. A video switcher 21 of the main box 2 is a switcher for switching output of video signals. The video switcher 21 receives video signals of the source unit of 3A to 3D via the connector of CN3AV to CN3DV, and receives video signals for monitoring from the video camera of 13A and 13B via the connector of CN13AV and CN13BV. The video switcher 21 selectively outputs the received video signals and video signals for monitoring to the zone unit of 4A to 4D via the connector of CN4AV to CN4DV by control of a controller 22.

An audio switcher 20 is a switcher for switching output of audio signals and speech signals. The audio switcher 20 receives audio signals of the source unit of 3A to 3D via the connector of CN3AA to CN3DA. The audio switcher 20 selectively outputs the received audio signals to the zone unit of 4A to 4D via the connector of CN4AA to CN4HA by control of the controller 22.

Furthermore, the audio switcher 20 receives speech signals from the door intercom of 11A and 11B via the connector of CN11A and CN11B, and receives speech signals from the zone unit of 4A to 4D via the connector of CN4AA to CN4HA. The audio switcher 20 selectively outputs the speech signals from the door intercom of 11A and 11B to the zone unit of 4A to 4D via the connector of CN4AA to CN4HA by control of the controller 22. Furthermore, the audio switcher 20 selectively outputs the speech signals from the zone unit of 4A to 4D back to the door intercom of 11A and 11B via the connector of CN11A and CN11B, and to other zone units of 4A to 4D via the connectors of CN4AA to CN4HA. Furthermore, the audio switcher 20 receives digital audio signals from the digital source unit 14 input via the connector CN14 after converting them into analog signals by a digital/analog converter circuit 25. The audio switcher 20 selectively outputs the audio signals input from the digital/analog converter circuit 25 to the zone unit of 4A to 4D via the connector of CN4AA to CN4HA by control of the controller 22.

The controller 22 is an arithmetic processing means for controlling the operation of this audio system 1, which executes a program recorded in a memory 26 and controls the operation of the each portion of this audio system 1. Because of this, the controller 22 is connected with the source units 3A to 3D and the zone units 4A to 4D by the connectors CN3AC to CN3DC and CN4AC to CN4HC, as well as with the door intercoms 11A and 11B via the CN11A and CN11B so as to be capable of detecting an operation of the button for calling

### [Detailed Configuration of the Keypad]

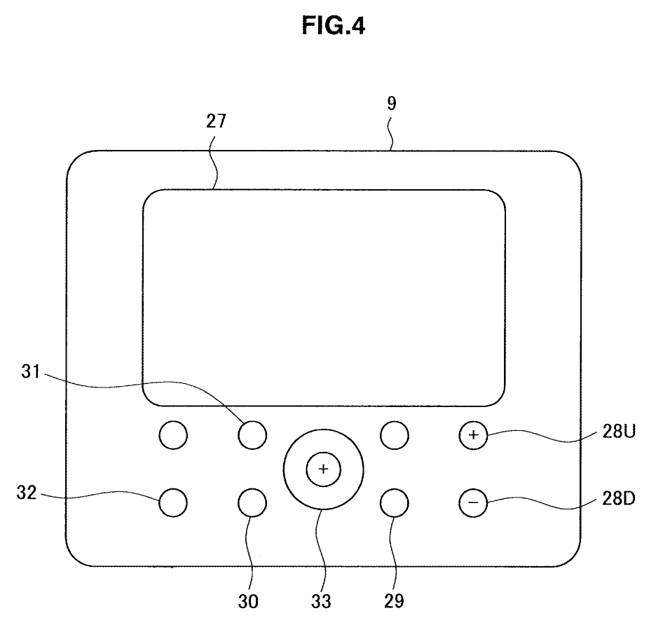

FIG. 4 is a plan view showing an external configuration of the keypad 9. The keypad has a protruding portion in a rectangular shape on the back surface, which is placed on the wall of each room by the protruding portion being embedded therein. The keypad 9 is provided with a display portion 27 for displaying a menu screen or the like as well as volume buttons 28U and 28D, a mute button 29, a menu display button 30, an execution/return button 31, a power button 32, a cursor/input button 33, and the like.

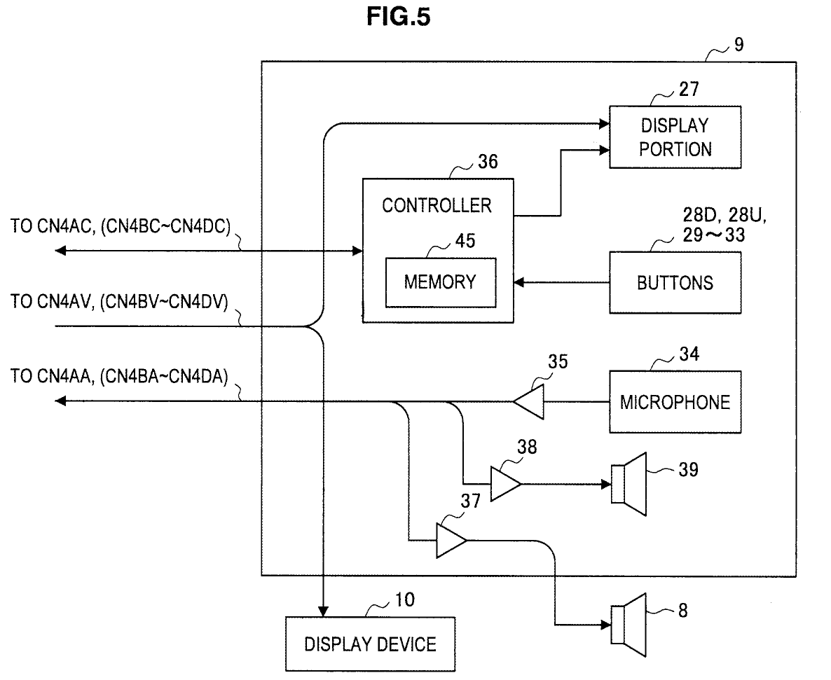

FIG. 5 is a block diagram showing the keypad 9. The keypad 9 acquires user's speech signals by the internal microphone 34, and amplifies these speech signals by an amplifier circuit 35. The keypad 9 outputs the speech signals output from the amplifier circuit 35 to the main box 2 by control of a controller 36. Furthermore, the keypad 9 drives an external speaker 8 by an amplifier circuit 37 by audio signals transmitted from the main box 2. Furthermore, the keypad 9 drives the internal speaker 39 by an amplifier circuit 38 by the audio signals transmitted from the main box 2.

In the keypad 9, the controller 36 is an arithmetic processing means for controlling the operation of this audio system 1 together with the controller 22 of the main box 2. The controller 36 executes a program recorded in a memory 45 and controls the operation of the each portion of this audio system 1. In addition, the keypad 9 is configured, to have a receiver for receiving remote control signals from a remote commander, capable of controlling the each portion by the operation of a remote commander as well in the same manner as when each of the buttons 28D to 33 is operated.

### [Control by the Controllers 22 and 36]

In this audio system 1, when the power button 32, the menu display button 30 or one of the corresponding buttons on the remote commander is operated, the controller 36 of the keypad 9 displays a main menu screen on the display portion 27 by an instruction of the controller 22 of the main box 2. In addition, the controller 36, when in the standby state, displays on the display portion 27 the time detected by the internal timer, and when the power button 32 or the corresponding button of the remote commander is operated, turns on power and switches display of the display portion 27. Furthermore, if the power of the main box 2 is not turned on at the point when the power of the keypad 9 is turned on, the controller 36 outputs control data to the controller 22 of the main box 2 and turns on the power of the main box 2 as well.

The controller 36 receives menu selection on this main menu screen by the operation of the cursor/input button 33 or the corresponding button on the remote commander. Furthermore, by this menu selection, the controller 36 displays a lower level menu screen following the instruction of the controller 22 and receives further menu selection. Because of this, the audio system 1 receives menu selection by displaying menus in a hierarchical structure.

Here, the controllers 22 and 36 are set up by selections from the menu, and the setup information is recorded in the memory 26 of the controller 36. In addition, the setup is, for example, a setting of icons and names for forming menu items of each of the source units 3A to 3D, a setting of names of the rooms provided with the zone units 4A to 4D, a setting of icons and names for forming menu items of the door intercoms 11A and 11B, and a correlation procedure of the video cameras 13 A and 13B with the zone units 4A to 4D or with the door intercoms 11A and 11B. Specifically, the names of the source units 3A to 3D are, for example, “FM broadcasting”, “AM broadcasting”, and “TV broadcasting”, and the names of the rooms provided with the zone units 4A to 4D are, for example, “living room” and “kitchen”. Furthermore, the name of the door intercoms 11A and 11B are “entrance” and the like. Furthermore, the correlation of the video cameras 13 A and 13B is, for example, when the video camera 13A is placed in the room provided with the zone unit 4A, a setting of a link between the video camera 13A and the zone unit 4A.

By the setup information recorded in the memory 26, the controller 22 orders the controller 36 to display a main menu screen, a lower level menu screen, or the like, and by this notification, the controller 36 displays the main menu screen, the lower level menu screen, or the like by using the icons and names set in the setup and receives various selections.

### [Control of the Source Units]

Here, when a menu of the source unit of 3A to 3D is selected on the main menu screen, the controller 36 gives the controller 22 of the main box 2 notice of this selection. By this notification, the controller 22 performs data communication with the external device 6 of the corresponding source unit of 3A to 3D and detects selectable content of this external device 6. The controller 22 gives the controller 36 notice of the detected selectable content, and based on this notification, the controller 36 displays a menu of the selectable content on a lower level menu screen. Furthermore, when content on the menu is selected, the controller 36 notifies the controller 22 of this selection.

By this notification, the controller 22 of the main box 2 controls the corresponding source unit of 3A to 3D, the audio switcher 20, and the video switcher 21, and receives the audio signals and the video signals of the content selected by the user and selectively outputs them to the corresponding zone unit of 4A to 4D.

The controller 36 of the keypad 9 outputs from the external speaker 8 these audio signals output from the main box 2 by the control of the amplifier circuit 37, and also turns on the power of the display device 10 and reproduces the video signals on the display device 10.

Furthermore, the controller 36 controls the operation of the amplifier circuit 37 and performs processing of volume control, muting, and release of muting, by the operations of the volume buttons 28U and 28D and the mute button 29 while reproducing music content and video content.

Furthermore, similarly, while reproducing music content and video content, the controller 36 switches display of the display portion 27 by the operation of the cursor/input button 33 and receives selection of source or content, and orders the main box 2 to switch source or content to this selected source or content. Following this instruction from the controller 36, the controller 22 of the main box 2 switches operations of the corresponding zone unit of 4A to 4D, the video switcher 21, and the audio switcher 20, and receives the audio signals and video signals of the content newly selected by the user and outputs them to the corresponding zone unit of 4A to 4D.

By this series of control of the controllers 22 and 36, in this audio system 1, each desired music content and video content can be used in each of the rooms provided with the zone units.

In addition, in case where the dedicated AV receiver is applied to the external device 6 and an external device is connected to the external input terminal of this AV receiver, and the source unit of this AV receiver is selected on the main menu screen, the controller 36 displays a menu giving an option of selecting this external device connected to the AV receiver, and displays a lower level menu screen. Furthermore, by the selection of the external device on the lower level menu screen, the controller 36 displays a menu of the selectable content of the corresponding external device. In addition, information necessary for the display of these lower level menu and/or content menu is acquired from the external device by the controller 22 of the main box 2, for example by data communication via the AV receiver. In addition, this menu display of the external device may be set at the setup.

### [Intercom Mode]

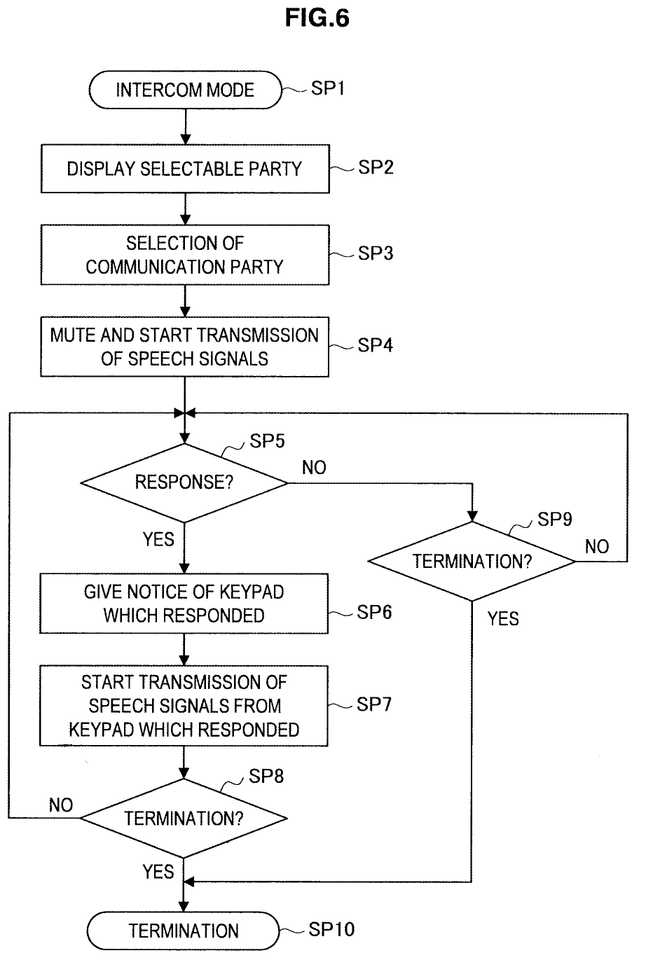

FIG. 6 is a flowchart showing a processing procedure of the controllers 22 and 36 in intercom mode. When a menu of the intercom mode is selected on the main menu screen, the controller 36 switches operation mode to intercom mode and starts this processing procedure, and goes from step SP1 to step SP2. Hereinafter, zone unit set to this intercom mode is referred to as “calling side zone unit”

In this step SP2, the controller 36 notifies the controller 22 of the main box 2 of intercom mode, and by this notification, the controller 22 notifies the controller 36 of selectable communication party based on the record of the memory 26. Here, the selectable communication party is all or one of the other zone units. By the notification from the controller 22 of the main box 2, the controller 36 displays a list of the selectable communication party by using the names of the rooms set at the setup.

Subsequently, the controller 36 goes to step SP3, and receives selection of communication party by the user and notifies the controller 22 of the main box 2 of the selected communication party. By this notification, the controller 22 of the main box 2 notifies, the keypad 9 of the communication party, of the name of the room provided with the calling side zone unit, and displays the name of the room of the calling side on the display portion 27 of the communication party side. In addition, in this case, if the power of the keypad 9 of the communication party is not turned on, the controller 22 turns on the power of this keypad 9 and notifies it of the name of the room.

In the subsequent step SP4, the controller 36 of the calling side stops the output of audio signals from the external speaker 8, and starts the output of speech signals acquired by the microphone 34 to the main box 2. In addition, when audio signals have not been output from the external speaker 8 up to then, the mute processing is omitted. Corresponding to the processing of the controller 36 in this step SP4, the controller 22 of the main box 2 controls the operation of the audio switcher 20, and outputs the audio signals output from the keypad 9 of the calling side to the keypad 9 of the communication party. The keypad 9 of the communication party stops the output of audio signals from the external speaker 8, and outputs the speech signals transmitted from the main box 2 from the internal speaker 39. In addition, also in this case, when audio signals have not been output from the external speaker 8 up to then, the mute processing is omitted.

In the subsequent step SP5, the controller 22 of the main box 2 judges whether a response from the keypad 9 of the communication party is obtained. Here, the keypad 9 of the controller 36 of the communication party starts the output of speech signals from the internal speaker 39. Furthermore, when a predetermined button is operated in this state, the controller 36 of the communication party notifies the main box 2 of its response as well as stopping the output of the speech signals from the internal speaker 39 and outputting the speech signals acquired by the microphone 34. Accordingly, when the predetermined button is operated on the keypad 9 of the communication party, the controller 22 of the main box 2 can obtain a positive result in this step SP5, and goes from the step SP5 to step SP6.

In this step SP6, the controller 22 of the main box 2 notifies the controller 36 of the calling side of this response, and by this notification, the controller 36 of the calling side displays on the display portion 27 the name of the room of the zone unit which responded. Furthermore, in the subsequent step SP7, the controller 22 controls the operation of the audio switcher 20 and transmits the speech signals from the keypad 9 which responded to the calling side.

Subsequently, the controllers 22 and 36 go to step SP8 and judges whether a termination of the intercom mode is ordered by judging whether the execution/return button 31 is operated on the keypad 9 of the calling side. If a negative result is obtained at this step SP8, the controllers 22 and 36 go back to the step SP 5. In response to this, if a negative result is obtained in the step SP5, the controllers 22 and 36 go forward to step SP9 and judges, in the same way as the step SP8, whether a termination of the intercom mode is ordered, and if a negative result is obtained here, they go back to the step SP5. On the contrary, if the execution/return button 31 is operated on the keypad 9 of the calling side, a positive result is obtained at the step SP8 or the step SP9, and thereby the controllers 22 and 36 go to step SP10 and terminate this processing procedure. In addition, by this termination of the processing procedure, the controller 36 of the calling side and the controller 36 of the communication party return to the former operation mode, and terminate the output of speech signals and the muting of audio signals.

Because of this, in this audio system 1, speech signals acquired by the keypad of the calling side are transmitted to the communication party and speech signals acquired by the keypad of the communication party are transmitted to the calling side, and each of the zone units is used as a terminal of the intercom.

### [Door Intercom Mode]

When an operation of the button for calling on the door intercom 11A or 11B is detected, the controller 22 of the main box 2 switches operation to door intercom mode. Here, the door intercom mode is an operation mode for causing the keypad 9 to function as a terminal of the door intercom of 11A or 11B. When the power of the main box 2 is turned down, the controller 22 turns on the power and switches operation mode to the door intercom mode.

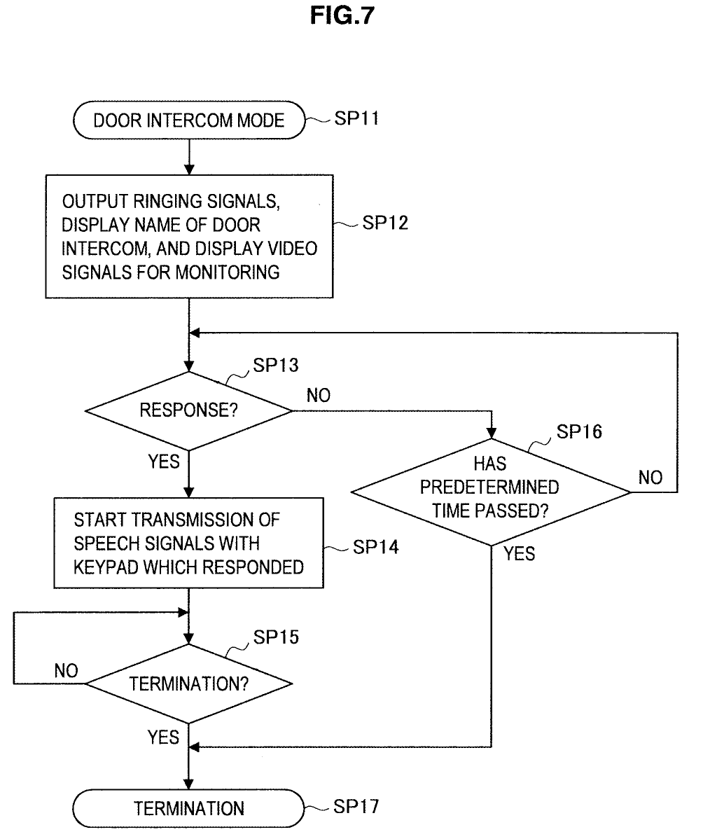

FIG. 7 is a flowchart showing a processing procedure of the controllers 22 and 36 in this door intercom mode. When starting this processing procedure, the controller 22 of the main box 2 goes from step SP11 to step SP12 and outputs ringing sound. Here, when the doorbell 12 is connected and either of the door intercoms 11A and 11B is related with the doorbell 12 by the set up processing, the controller 22 activates the doorbell 12 and outputs ringing signals. On the contrary, when the doorbell 12 is not connected or neither of the door intercoms 11A and 11B is related with the doorbell 12, the controller 36 controls the zone unit of 4A to 4D and outputs ringing signals from the internal speaker 39.

Furthermore, the controller 36 gives the zone unit of 4A to 4D notice of the name of the corresponding door intercom 11A or 11B set at the setup, and displays this name on the display portion 27. Furthermore, when either of the video cameras 13A and 13B is related with either of the door intercoms 11A and 11B, the controller 22 outputs video signals for monitoring of the related video camera 13A or 13B to the zone unit of 4A to 4D and the controller 36 displays them on the display portion by control of the video switcher 21. Because of this, in this audio system 1, it is possible to see a visitor from a pre-set room.

Subsequently, the controller 22 goes to step SP13 and judges whether a response from the zone unit is obtained. Here, when a predetermined button is operated, the controller 36 of the keypad 9 notifies the main box 2 of the response as well as stopping the output of audio signals and starting the output of speech signals acquired by the microphone 34. By this response from the controller 36, the controller 22 of the main box 2 can obtain a positive result at the step SP13, and goes from the step SP13 to step SP14.

At this step SP14, the controller 22 starts transmission and reception of speech signals between the door intercom 11A or 11B and the zone unit which responded by control of the audio switcher 20. That is, the controller 22 starts the output of speech signals of the door intercom 11A or 11B to the zone unit which responded, and starts the output of speech signals of the zone unit which responded to the door intercom 11A or 11B.

Subsequently, the controller 22 goes to step SP15 and judges whether a termination of the door intercom mode is ordered by judging whether the execution/return button 31 is operated on the keypad which responded. If a negative result is obtained at this step SP15, the controller 22 repeats the step SP15. On the other hand, if a negative result is obtained at the step SP13, the controller 22 goes to step SP16 and judges whether a predetermined time has passed, and if a negative result is obtained here, it goes back to the step SP13. On the contrary, if a positive result is obtained at the step SP15 or SP16, the controller 22 goes to step SP17 and terminates this processing procedure. In addition, by this termination of the processing procedure, the keypad 9 which responded returns to the former operation mode, and terminate the output of speech signals, the muting of audio signals, and the like.

Because of this, in this audio system 1, the keypad 9 placed in each room is used as a terminal device of the door intercom of 11A and 11B and transmits and receives speech signals with the door intercom of 11A and 11B.

### [Control of the Controllers 22 and 36 in Monitor Mode]

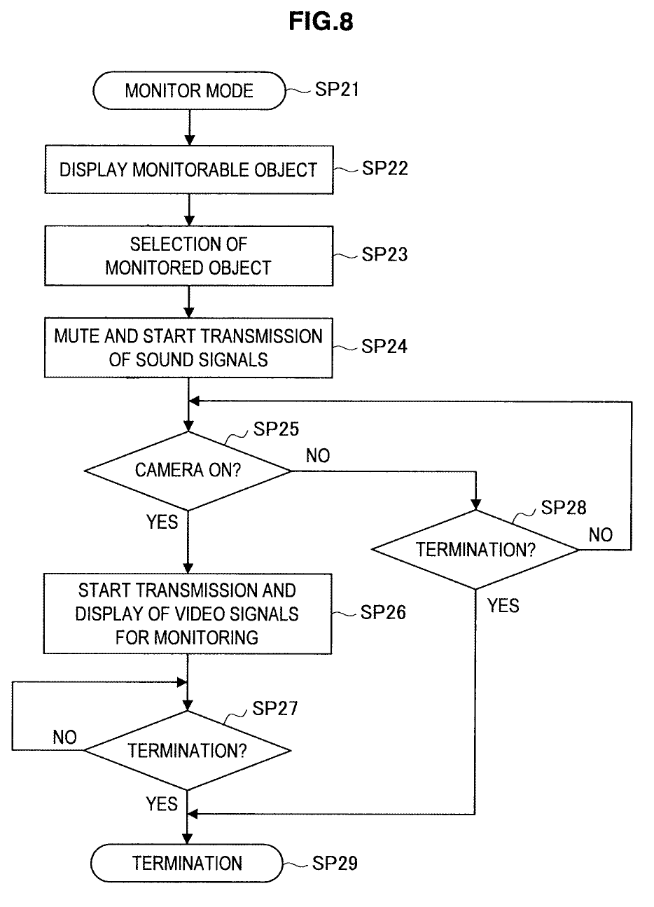

FIG. 8 is a flowchart showing a processing procedure of the controllers 22 and 36 in monitor mode. Here, the monitor mode is an operation mode for setting one of the rooms provided with the zone units 4A to 4D to a monitored object, and monitoring sound or sound and video of the monitored object by the zone unit in the different room. When a menu of the monitor mode is selected on the main menu screen, the controller 36 of the keypad 9 switches operation mode to monitor mode and starts this processing procedure, and goes from step SP21 to step SP22.

At this step SP22, the controller 36 of the keypad 9 displays a list of monitorable objects based on the record of the memory 26 by the data communication with the controller 22. Here, by the notification from the controller 22, the controller 36 displays a list of the names of the rooms provided with the other zone units and displays the list of monitorable objects.

Subsequently in step SP23, the controller 36 receives selection of monitored object, and gives the controller 22 of the main box 2 a notice of this selection. Furthermore, when audio signals have been reproduced by the external speaker 8 up to then, the controller 36 stops the output of the audio signals.

By this notification from the controller 36, the controller 22 of the main box 2 orders the keypad 9 in the monitored object to switch operation, and stops the output of audio signals of the keypad 9 in the subsequent step SP24. Furthermore, the controller 22 sets the keypad 9 to output the audio signals acquired by the microphone 34 to the main box 2 by control of the amplifier circuit 38. Furthermore, the controller 22 controls the audio switcher 20, and outputs the sound signals output from the keypad in the monitored object to the keypad 9 in monitor mode and outputs them from the internal speaker 39. Because of this, in this audio system 1, the keypad 9 in monitor mode starts monitoring sound of another room.

Here, when the zone unit in the monitored object is related with either of the video cameras 13A and 13B in the set up processing, the controller 22 notifies the keypad 9 in monitor mode of this correlation. In the keypad 9 in monitor mode, the controller 36 displays a menu of the video monitor on the display portion 27 by this notification when starting monitoring sound signals. Furthermore, if selection from the monitor mode menu is detected, the controller 36 gives the controller 22 of the main box 2 a notification.

The controller 22 of the main box 2 judges presence or absence of this notification at step SP25, and if a positive result is obtained here, it goes to step SP26. Here, the controller 22 outputs the corresponding video signals for monitoring to the keypad 9 in monitor mode by control of the video switcher 21, and these video signals for monitoring are displayed on the display portion 27 in the keypad 9 by control of the controller 36. Because of this, in this audio system 1, the keypad 9 in monitor mode starts monitoring video of another room.

Subsequently, the controller 22 goes to step SP27, and here, it judges whether a termination of the monitor mode is ordered by judging whether the execution/return button 31 is operated on the keypad 9 in monitor mode. If a negative result is obtained at this step SP27, the controller 22 goes to step SP28 and repeats the step SP27. On the other hand, if a negative result is obtained at the step SP25, the controller 22 judges in the same way as the step SP27, whether a termination of the monitor mode is ordered, and if a negative result is obtained here, it returns to the step SP25. On the contrary, if a positive result is obtained at the step SP27 or SP28, the controller 22 goes to step SP29 and terminates this processing procedure. In addition, by this termination of the processing procedure, the keypads of the monitored object and in monitor mode return to the former operation, and terminate the output of sound signals, the muting of audio signals and the like.

### [Control of the Digital Source Unit]

When a menu of the digital source unit 14 is focused on the main menu screen, the controller 22 of the main box 2 performs data communication with this digital audio device 15 via the digital wallport 16, and acquires attribute information of this digital audio device 15. The controller 22 detects the device name of the audio device 15 by this attribute information, and notifies the corresponding keypad 9 of this device name and displays it on the main menu screen. In addition, this device name here is, for example, “portable music player”, “portable phone with music playback function”, or the like, and the controller 36 displays such device name by using the name set at the setup.

Furthermore, when receiving the notification of device name selection from the controller 36, the controller 22 detects selectable menus of the digital audio device 15 by the same data communication with digital audio device 15. The controller 22 notifies the corresponding keypad 9 of the detected menus, and by this notification, the controller 36 of the keypad 9 displays the detected menus on a lower level menu screen. In addition, the selectable menu here is, for example in the case of a portable music player, a playlist, artist, album, genre, music, and the like.

Furthermore, when receiving the notification of menu selection on the lower level menu screen from the controller 36, the controller 22 detects selectable menu items by the same data communication with digital audio device 15, and gives the controller 36 a notice of the selectable menu items and displays them.

Because of this, the controller 36 receives content selection by the same user interface as when the digital audio device 15 is directly operated, and controls operation of the each portion so as to output the selected content to the corresponding zone unit.

### [Party Mode]

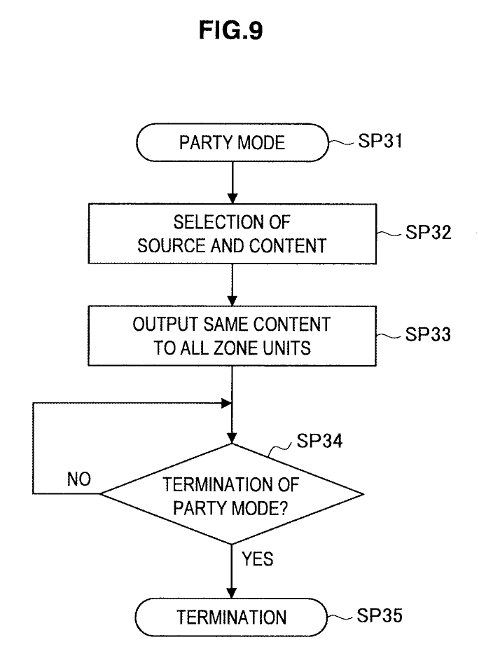

FIG. 9 is a flowchart showing a processing procedure of the controllers 22 and 36 in party mode. Here, the party mode is an operation mode for reproducing the same content of the same source in all of the zone units. When a menu of the party mode is selected on the main menu screen, the controller 36 of the keypad 9 switches operation mode to party mode and starts this processing procedure, and goes from step SP31 to step SP32.

Here, the controller 36 notifies the main box 2 of the switch of operation mode to the party mode. Furthermore, the controller 36 displays a similar menu screen as above and receives selection of source or content, and notifies the main box 2 of this selection of source or content.

In the subsequent step SP33, the controller 22 of the main box 2 outputs to all of the zone units, the audio signals and video signals of the source or content whose selection is sent at the step SP32, by control of the video switcher 21 and the audio switcher 20. Furthermore, corresponding to this, the controllers 36 of all of the zone units reproduce the audio signals and video signals output from the main box 2. In addition, in this case, if the power of the keypad 9 is not turned on, the controller 36 turns on the power and reproduces the video signals and audio signals. Because of this, in this audio system 1, the content selected by one zone unit is reproduced in all of the zone units. In addition, the controller 22 receives an operation regarding switch of source or content in all of the zone units.

Subsequently, the controller 22 of the main box 2 judges whether a termination of the party mode is ordered by judging whether the execution/return button 31 is operated in any of the zone units. If a negative result is obtained at this step SP34, the controller 22 repeats the step SP34. On the contrary, if a positive result is obtained at the step SP34, the controller 22 goes to step SP35, and terminates this processing procedure and returns the setting of the each portion to the state before the party mode is started.

### [Update Processing]

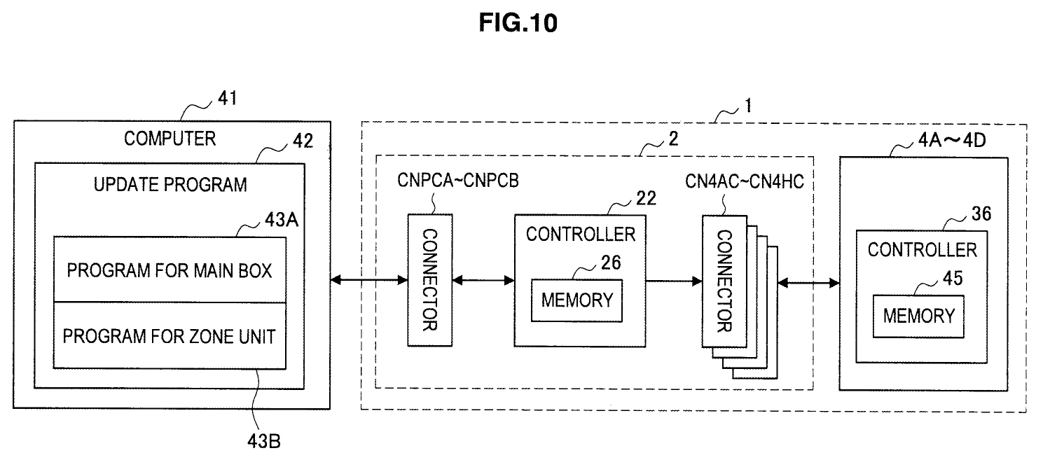

FIG. 10 is a block diagram for explaining an update processing. This audio system 1 executes an update program 42 in a computer 41 connected with the main box 2, and updates programs recorded in the memory 26 of the main box 2 and the memory 45 of each of the zone units 4 to 4D, using a program 43A for the main box and a program 43B for the zone units preserved in this update program 42 respectively.

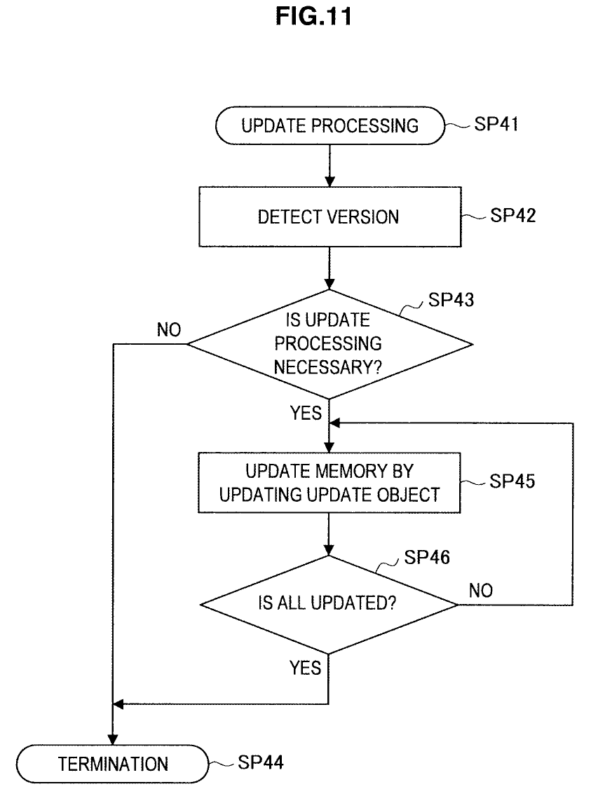

FIG. 11 is a flowchart showing a processing procedure of the computer 41 by this update program. When an execution of this update program is ordered, the computer 41 goes from step SP41 to step SP42. At this step SP42, the computer 41 detects the version of the program preserved in the memory 26 of the controller 22 by data communication with the controller 22 of the main box 2. Furthermore, by data communication with the controller 36 of the each keypad 9 via the controller 22, the computer 41 detects the version of the program preserved in the memory 45 of the controller 36.

Subsequently, the computer 41 goes to step SP43. Here, the computer 41 judges the each version detected at the step SP42 by the versions of the programs 43A and 43B preserved in the update program, and detects the main box 2 or the keypads 9 which has to be updated. The computer 41 judges whether updating is necessary based on this detection result, and if a negative result is obtained here, it goes from the step SP43 to step SP44 and terminates this processing procedure.

On the contrary, when there exists the main box 2 or the keypad 9 which has to be updated, a positive result is obtained at the step SP43, and the computer 41 goes from the step SP43 to step SP45. Here, the computer 41 sets the main box 2 or one keypad 9 which has to be updated to the update object. Furthermore, the computer 41 transmits the preserved program 43A or 43B to this update object, and updates the memory 26 or 45 by this transmitted program 43A or 43B.

Subsequently, the computer 41 goes to step SP46 and judges whether all of the main box 2 and keypads 9 which have to be updated is updated. If a positive result is obtained here, the computer 41 goes to step SP44 and terminates this processing procedure. On the contrary, if a negative result is obtained at the step SP46, the computer 41 switches update object and goes back to the step SP45.

Because of this, the audio system 1 sequentially updates the programs of the main box 2 and the keypads 9 by the computer 41 connected with the main box 2.

### Operation of the Embodiment

In the above configuration, in the audio system 1 (FIG. 1 to FIG. 5), when source or content are selected on the keypad 9 provided in any of the zone units 4A to 4D, the main box 2 is notified of this selection. Furthermore, by the notification, the each portion is controlled by the controller 22 provided in the main box 2 and the video signals and audio signals of the selected content by the user are selectably output to the corresponding zone unit of 4A to 4D via the video switcher 21 and the audio switcher 20. These video signals and audio signals output from the main box 2 are transmitted to each of the zone units 4A to 4D via the cables installed within the walls and reproduced by the display device 10 and the speaker 8.

Because of this, in the audio system 1, source is shared among each room and a desired content can be enjoyed in the each room by the operation of the keypad 9 provided in the each room. Furthermore, when an audio device or a video device provided in a listening room or the like is applied to the external device 6 of the source unit of 3A to 3D, music content and video content listened and viewed in the listening room or the like can be enjoyed in the each room.

In the audio system 1, as this audio device placed in the listening room, there is prepared the dedicated AV receiver having a function of receiving FM broadcasting and television broadcasting, an external input function, a selector function, and an external output function, which is controllable by the main box 2. Accordingly, when this dedicated AV receiver is applied to the external device 6, various sources can be added by using the external input terminal of this AV receiver, thereby enabling further expansion of the extensibility of the audio system. Furthermore, source can be added without the addition of source unit in this case, and thereby source can be added without a large-scale construction such as installing more cables within the walls of a house, which enables the system configuration of this kind of audio system 1 to be flexibly and easily changed.

Furthermore, in the audio system 1, the digital source unit 14 can be connected with the main box 2, and when this digital source unit 14 is selected on the keypad 9 provided in any of the zone units 4A to 4D, the main box 2 is notified of this selection. Furthermore, by this notification, the controller 22 provided in the main box 2 controls the each portion and there is displayed a menu of the digital audio device provided in the digital source unit 14 and content selection is received. Furthermore, by this selection, the main box 2 controls the digital audio device 15 and the audio signals output from the digital audio device 15 are transmitted to the corresponding zone unit of 4A to 4D and reproduced. Because of this, in the audio system 1, by using the digital audio device 15 such as a portable music player as the source, for example, the music content of this digital audio device 15 can be enjoyed in each room.

In this audio system 1, the main box 2 is configured capable of receiving video signals for monitoring, and these video signals for monitoring are selectively output to the zone unit of 4A to 4D in door intercom mode and monitor mode by a direction of the user detected via the keypad 9. Furthermore, in each of the zone units 4A to 4D, these video signals for monitoring are displayed on the display portion 27 of the keypad 9. Because of this, in this audio system 1, by making effective use of the configuration for outputting video signals and audio signals to each of the zone units 4A to 4D, video signals for monitoring can be also monitored in rooms provided with the zone units 4A to 4D. Accordingly, in this audio system 1, a video camera for outputting video signals for monitoring can be provided as necessary and used for various monitoring or the like, which can further expand the function and can expand the availability.

More specifically, the main box 2 is configured such that the door intercoms 11A and 11B can be connected thereto, and in door intercom mode, ringing signals are output from the doorbell 12 or the zone unit of 4A to 4D by the operation of the button for calling on this door intercom 11A or 11B. Furthermore, when the user operates any of the zone units 4A to 4D and responses, speech signals are transmitted and received between the zone unit of 4A to 4D which responded and the door intercom 11A or 11B. Because of this, in the audio system 1, by using the keypad 9 provided in the zone unit of 4A to 4D as a terminal device of the door intercom, the user can respond to a visitor by voice.

In the audio system 1, when either of the door intercoms 11A and 11B is related with either of the video cameras 13A and 13B in the previous setup processing, in the processing of the door intercom mode, video signals for monitoring from the video camera 13A or 13B are output to the corresponding zone unit of 4A to 4D and displayed by a direction of the user. Because of this, in this audio system 1, by installing the video camera 13A or 13B at the entrance, for example, it is possible to see a visitor with this camera 13A or 13B, which enables more expansion of the function than before.

On the other hand, in the monitor mode, a monitored object is set by the operation of any of the zone units 4A to 4D, and the zone unit provided in the monitored object is set to “monitoring zone unit” and the zone unit which the user operated is set to “setting zone unit”. In the monitor mode, sound signals are acquired by the zone unit of 4A to 4D set to the monitoring zone unit, and these sound signals are transmitted to the setting zone unit via the main box 2. Furthermore, in this setting zone unit, these sound signals are output from the internal speaker 8. Because of this, in the audio system 1, by monitoring the room provided with another zone unit by sound, for example, it is possible to monitor this room.

In the audio system 1, when the zone unit of 4A to 4D set to the monitoring zone unit is related with either of the video cameras 13A and 13B in the previous setup processing, in this monitor mode, video signals for monitoring from the video camera 13A or 13B are output to the corresponding zone unit of 4A to 4D and displayed by a direction of the user. Because of this, in this audio system 1, it is possible to monitor the room provided with another zone unit also by video in addition to sound, which can further expand the function and can expand the availability.

In particular, the output of video signals for monitoring in the door intercom mode and monitor mode is set by the correlation procedure in the setup processing, thereby enabling the expansion of the availability flexibly responding to the installation position of video camera varying due to the system configuration. That is, by installing two video cameras 13A and 13B at the entrance and at the back door respectively with the door intercoms 11A and 11B, it is possible to see a visitor, and furthermore, instead of this, the video cameras 13A and 13B can be installed at the living room and a pet room respectively and used for monitoring a pet or the like.

On the other hand, in the audio system 1, when the intercom mode is selected in any of the zone units 4A to 4D by the user, this zone unit is set to the calling side and can receive selection of another zone unit of 4A to 4D for the communication party. In the audio system 1, speech signals acquired by the microphones 34 embedded in the keypads 9 are transmitted and received between this calling side and the communication party via the main box 2. Because of this, in the audio system 1, each keypad 9 of the zone units 4A to 4D can be used also as a terminal device of the intercom, which can also expand the availability.

On the other hand, when the party mode is selected in any one of the zone units 4A to 4D by the user, the video signals and audio signals of the source or content selected in this zone unit of 4A to 4D are output to all of the zone units 4A to 4D from the main box 2. Because of this, in the audio system 1, when a party is held in a house, for example, the same music content or video content can be provided to each room, which enables more improvement in usability than before.

Furthermore, in this party mode, when a switch of source or content is ordered in any of the zone units 4A to 4D including the zone unit which selected the party mode, video signals and audio signals output to all of the zone units 4A to 4D are switched in the main box 2 by this direction. Because of this, in this audio system 1, the same music content or video content can be provided to each room, and the content can be changed by the operation of accessible zone unit of 4A to 4D, for example in the party, and which can further improve the usability.

Incidentally, in the audio system 1, the programs stored in the memories 26 and 45 of the main box 2 and the keypad 9 respectively are performed by the controls 22 and 36 and the each portion are controlled. Accordingly, the programs stored in these memories 26 and 45 have to be updated. However, since the keypad 9 is provided in each room, the user has to move to a room provided with the keypad 9 each time to update the each keypad 9 if there is nothing prepared for the situation. Consequently, the update processing is considerably troublesome.

In this kind of audio system 1 in particular, the keypad 9 may be updated after a long period of time, under which situation, even the whereabouts of the keypad 9 may be difficult to be found. Consequently, in this case, some of the keypads 9 which configure the audio system are difficult to be updated, after all. Consequently, it is difficult to reliably update the audio system 1 as a whole.

Accordingly, in the audio system 1 (FIG. 10 and FIG. 11), the main box 2 is provided with the connectors CNPCA and CNPCB to which computers are connected. Furthermore, these computers transmit data for update to the keypad 9 via the main box 2 and sequentially update the keypads 9 as well as the main box 2. Because of this, in the audio system 1, the keypads 9 provided in each room can be sequentially updated from the position where the main box is placed, which enables more considerable simplification of the update processing than before.

Furthermore, the data for update are transmitted by using cables for data communication which transmit control data from the keypad 9, and thereby also the keypad 9 whose whereabouts is unknown can be reliably updated.

### Advantages of the Embodiment

According to the above configuration, when the party mode is selected in one of the plurality of zone units, the audio signals of one source unit are output to all of the plurality of zone units, and hence more improvement in usability of this kind of audio system can be obtained than before.

Furthermore, in the party mode, selection of source or content is received from all of the zone units and video signals and audio signals to be output to all of the zone units are switched, thereby enabling further improvement in usability.

Although a preferred embodiment of the present invention is described in the foregoing with reference to the drawings, it should be understood by those skilled in the art that various modifications, combinations, sub-combinations and alterations may occur depending on design requirements and other factors insofar as they are within the scope of the appended claims or the equivalents thereof.

### <Modification>

Furthermore, in the above-described embodiment, there is described a case where a direction of terminating the party mode is received by the zone unit in which the party mode is selected. However, the present invention is not limited thereto, and a direction of terminating the party mode may be received by other zone unit as necessary.

Furthermore, in the above-described embodiment, there is described a case where the same audio signals and video signals are transmitted to all of the zone units in the party mode. However, the present invention is not limited thereto, and zone units for being provided with content in the party mode may be set in the setup processing, for example, and the audio signals and video signals may be transmitted to all of these zone units for being provided with content.

Furthermore, in the above-described embodiment, there is described a case where the same video signals and audio signals are transmitted to all of the zone units in the party mode. However, the present invention is not limited thereto, and transmission of video signals may be stopped and only regarding the audio signals, the same audio signals may be transmitted to all of the zone units, as necessary.

The present application contains subject matter related to that disclosed in Japanese Priority Patent Application JP 2008-282736 filed in the Japan Patent Office on 4 Nov. 2008, the entire content of which is hereby incorporated by reference.

The present invention can be applied to an audio system for transmitting audio signals and video signals to each room of a house via cables installed within the walls of the house, and reproducing these audio signals from a speaker embedded in the wall, for example.

What is claimed is:

1. An audio system comprising:
a plurality of source units each of which outputs audio signals and video signals;
a plurality of zone units for outputting control data according to user's operation and outputting audio signals from a speaker as well as displaying video signals, each of the plurality zone units being placed at a desired position in a house; and
a main box for selectably outputting the audio signals and video signals of the source unit to the zone unit according to the control data,
wherein when a party mode is selected in one of the plurality of zone units,
the main box outputs, by the control data, the audio signals of the source unit selected in the one zone unit to all of the plurality of zone units.

2. The audio system according to claim 1,
wherein when source unit and/or content is selected in any of the plurality of zone units in the party mode,
the main box audio signals to be output to all of the plurality of zone units are switched to the audio signals of the selected source unit and/or content.

3. A main box for selectively outputting audio signals and video signals output from a plurality of source units to a zone unit by control data from the zone unit, and when a party mode is selected in one of the plurality of zone units, outputting, by the control data, audio signals of the source unit selected in the one zone unit to all of the plurality of zone units, the main box being connected, via the cables installed in the walls within the house, to the plurality of zone units each of which outputs video signals and audio signals and to the plurality of source units each of which reproduces video signals and audio signals.
